(19) United States
(12) Patent Application Publication
(10) Pub. No.: US 2012/0182511 A1
(43) Pub. Date: Jul. 19, 2012

(54) LIQUID CRYSTAL DISPLAY DEVICE

(76) Inventors: Yuhko Hisada, Osaka-shi (JP); Takehisa Sakurai, Osaka-shi (JP); Mitsuhiro Murata, Osaka-shi (JP); Tsuyoshi Okazaki, Osaka-shi (JP); Katsuhiko Morishita, Osaka-shi (JP)

(21) Appl. No.: 13/498,732

(22) PCT Filed: May 10, 2010
(86) PCT No.: PCT/JP2010/057868

§ 371 Date: Mar. 28, 2012

(30) Foreign Application Priority Data
Sep. 30, 2009 (JP) 2009-226117

(51) Int. Cl. G02F 1/1343

(52) U.S. Cl. 349/139

(57) ABSTRACT

The present invention provides a liquid crystal display device that adopts a TBA mode that can suppress the occurrence of unevenness of luminance. The liquid crystal display device includes a pair of substrates disposed facing each other, and a liquid crystal layer sandwiched between the pair of substrates. One of the pair of substrates has a pair of comb-tooth-shaped electrodes. The pair of electrodes are disposed to planarly face each other in a pixel, and are formed by patterning the same layer. The liquid crystal layer includes p-type nematic liquid crystal, and is driven by an electric field generated between the pair of electrodes. The p-type nematic liquid crystal is vertically aligned with respect to the surfaces of the pair of substrates when no voltage is applied. A spacing between the pair of electrodes varies in a longitudinal direction of the pair of electrodes.

### TECHNICAL FIELD

The present invention relates to a liquid crystal display device. More specifically, the present invention relates to a display device that is suitably used for a liquid crystal display device that adopts a transverse bend alignment (TBA) mode.

### BACKGROUND ART

Active matrix liquid crystal display devices that use an active element typified by a thin film transistor (TFT) are widely used as display devices because the display devices are thin and lightweight, and have high image quality that is comparable to a cathode-ray tube.

The display systems of such active matrix liquid crystal display devices are broadly classified into the following two kinds of display systems.

The first kind is a longitudinal electric field system. According to this system, a liquid crystal layer is enclosed between a pair of substrates on which transparent electrodes are formed, respectively, and by applying a driving voltage to the two transparent electrodes, the liquid crystal layer is driven by an electric field in a direction that is approximately perpendicular to the substrate interfaces, and light that is transmitted through one of the transparent electrodes and is incident on the liquid crystal layer is modulated and displayed.

However, in an active matrix liquid crystal display device that adopts a longitudinal electric field system, there is a large brightness change when the viewing angle direction is changed. In particular, when a gradation display is performed, there are cases in which the gradation level may be inverted depending on the viewing angle direction.

The other kind of display system is a transverse electric field system. According to this system, a liquid crystal layer is enclosed between a pair of substrates, and by applying a driving voltage to two electrodes that are formed on the same substrate or on the two substrates, the liquid crystal layer is driven by an electric field in a direction that is approximately parallel to the substrate interfaces, and light that is incident on the liquid crystal layer from one of the substrates is modulated and displayed.

An IPS (in-plane switching) mode is known as a liquid crystal mode according to the transverse electric field system.

The IPS mode realizes a wide viewing angle because liquid crystal molecules are rotated within the substrate plane. However, since the liquid crystal molecules rotate in only one direction, there is room for improvement in the respect that coloring occurs, in particular, on a white display when viewed from an oblique direction. Various methods have been disclosed as means for solving this problem.

For example, a liquid crystal display device that adopts the IPS mode has been disclosed in which pixel electrodes and common electrodes are formed in a V shape, and the degrees of bending of the V shape of the respective electrodes are varied so that spacings between the pixel electrodes and common electrodes vary in the pixels (for example, see Patent Document 1).

A liquid crystal display device that adopts the IPS mode has also been disclosed in which an opposed electrode is parallel with the initial alignment direction of liquid crystal molecules, pixel electrodes have angles of θ and −θ with respect to the initial alignment direction of the liquid crystal molecules, and the pixel electrodes further include an inclined portion (for example, see Patent Document 2).

However, similarly to a TN (twisted nematic) mode and an MVA (multi-domain vertical alignment) mode according to the longitudinal electric field system, there is room for further improvement of the IPS mode in the respect that the response is slow.

Further, as a liquid crystal mode according to the transverse electric field system other than the IPS mode, a liquid crystal display device has been disclosed that includes a first and second substrate that oppose each other, a liquid crystal layer enclosed between the first and second substrates, a first electrode provided on the first substrate, and a second electrode provided on the second substrate, wherein the first electrode and the second electrode are composed of a plurality of electrode components that are arranged in parallel within a single pixel, and at least one of an electrode width and an electrode gap of the electrode components of the electrodes is non-uniform (for example, see Patent Document 3).

A TBA (transverse bend alignment) mode is also known. The TBA mode is a display system that uses a p-type nematic liquid crystal as a liquid crystal material, and regulates the alignment orientation of liquid crystal molecules by driving the liquid crystal by means of a transverse electric field using a pair of comb-tooth-shaped electrodes that are provided on one of the pair of substrates. When no voltage is applied, the liquid crystals exhibit a vertical alignment, and when a voltage is applied, the liquid crystals exhibit a bend-shaped liquid crystal alignment without undergoing an in-plane rotation, and hence a high-speed response, a wide viewing angle characteristic, and a high contrast characteristic can be achieved. Thus, the practical value thereof is extremely high.

In each of the IPS mode (for example, the liquid crystal mode described in Patent Document 1 or 2), the liquid crystal mode described in Patent Document 3, and the TBA mode, a liquid crystal layer is driven by a transverse electric field generated by a pixel electrode that is connected to an active element such as a TFT and a common electrode that is an electrode that is common to each pixel.

### CITATION LIST

### Patent Document

[Patent Document 1] JP 3427981 B1
[Patent Document 2] JP 3934141 B1
[Patent Document 3] JP 2000-81641A

### SUMMARY OF THE INVENTION

However, according to the conventional TBA mode, in the manufacturing process, when minute variations in finish arise due to various factors, in some cases, unevenness of luminance, more specifically, for example, localized variations in brightness or so-called “block separation” may be visually recognized. The term “block separation” refers to a phenomenon whereby, regardless of signals of the same gray scale level being input to all pixels, the screen appears to be separated into a plurality of comparatively large blocks of different brightnesses. The reason is that, when there are variations in the finish of electrodes in the TBA mode, electric field strengths change because the distances between electrodes vary, and as a result the voltage-transmittance (V-T) characteristics of the liquid crystal vary.

The present invention has been made in view of the above circumstances and an object of the present invention is to provide a liquid crystal display device adopting the TBA mode that can suppress the occurrence of unevenness of luminance.

### DISCLOSURE OF THE INVENTION

The inventors have conducted various studies on liquid crystal display devices that adopt a TBA mode that can suppress the occurrence of unevenness of luminance, and have found that unevenness of luminance is particularly liable to occur when a pair of comb-tooth-shaped electrodes are formed by patterning the same layer. Further, the inventors found that, in such a case, by changing the spacing between the two electrodes in a longitudinal direction of the two electrodes, even if variations or changes arise in the finish, variations in the V-T characteristics can be effectively suppressed. Having realized that this idea can beautifully solve the above problem, the inventors have arrived at the present invention.

More specifically, the present invention provides a liquid crystal display device including a pair of substrates disposed facing each other, and a liquid crystal layer that is sandwiched between the pair of substrates, wherein: one of the pair of substrates has a pair of electrodes that have a comb-tooth shape; the pair of electrodes are disposed to planarly face each other in a pixel, and are formed by patterning a same layer; the liquid crystal layer includes p-type nematic liquid crystal, and is driven by an electric field generated between the pair of electrodes; the p-type nematic liquid crystal is vertically aligned with respect to surfaces of the pair of substrates when no voltage is applied; and a spacing between the pair of electrodes varies in a longitudinal direction of the pair of electrodes.

Note that, as used herein, the term “vertical” need not necessarily refer to a state that, strictly speaking, is vertical, as long as the state is within a range that enables a liquid crystal display device to function according to the TBA mode. That is, the term “vertical” described above includes a substantially vertical state.

The configuration of the liquid crystal display device of the present invention is not especially limited by other components as long as it essentially includes such components.

Preferable embodiments of the liquid crystal display device of the present invention are mentioned in more detail below. The following embodiments may be employed in combination.

Preferably, the pair of electrodes are formed on a same layer. Thus, the transmittance and contrast can be improved.

Preferably, one of the pair of substrates includes: a plurality of gate bus lines and a plurality of source bus lines that intersect; a plurality of pixels surrounded by the plurality of gate bus lines and the plurality of source bus lines; and a plurality of active elements provided in correspondence to each pixel. Thus, the liquid crystal display device of the present invention is preferably of an active matrix type.

Note that the aforementioned pixels may be picture elements.

Preferably, one of the pair of electrodes is disposed at a position that is further on the liquid crystal layer side than the plurality of gate bus lines and the plurality of source bus lines, and is disposed so as to be superimposed on at least one of the plurality of gate bus lines and the plurality of source bus lines (more preferably, both the plurality of gate bus lines and the plurality of source bus lines). Thus, without adding to the layers or number of processes, the influence of the potential of the source bus lines and/or the gate bus lines (more preferably, the source bus lines and the gate bus lines) can be effectively blocked by one of the pair of electrodes.

### ADVANTAGEOUS EFFECTS OF THE INVENTION

According to the liquid crystal display device of the present invention, a liquid crystal display device adopting a TBA mode that can suppress the occurrence of unevenness of luminance can be realized.

### BRIEF DESCRIPTION OF THE DRAWINGS

FIG. 1 is a planar schematic view showing a configuration of a liquid crystal display device according to Embodiment 1.

FIG. 2 is a cross-sectional schematic diagram showing a configuration of the liquid crystal display device according to Embodiment 1.

FIG. 3 is graph illustrating V-T characteristics of a liquid crystal display device that adopts a TBA mode.

FIG. 4 is graph illustrating slopes of V-T curves shown in FIG. 3.

FIG. 5 is a planar schematic view showing a configuration of a liquid crystal display device according to a comparative form.

FIG. 6 is a planar schematic view showing a configuration of the liquid crystal display device according to Embodiment 1.

FIG. 7 is a planar schematic view showing a configuration of the liquid crystal display device according to Embodiment 1.

FIG. 8 is a graph illustrating V-T characteristics of a liquid crystal display device according to a comparative form.

FIG. 9 is a graph illustrating V-T characteristics of the liquid crystal display device according to Embodiment 1.

FIG. 10 is a graph illustrating V-T characteristics of the liquid crystal display device according to Embodiment 1.

FIG. 11 is a planar schematic view illustrating a configuration of a modification example of the liquid crystal display device according to Embodiment 1.

FIG. 12 is a planar schematic view illustrating a configuration of a modification example of the liquid crystal display device according to Embodiment 1.

FIG. 13 is a planar schematic view illustrating a configuration of a modification example of the liquid crystal display device according to Embodiment 1.

FIG. 14 is a planar schematic view illustrating a configuration of a modification example of the liquid crystal display device according to Embodiment 1.

FIG. 15 is a planar schematic view illustrating a configuration of a modification example of the liquid crystal display device according to Embodiment 1.

FIG. 16 is a planar schematic view illustrating a configuration of a modification example of the liquid crystal display device according to Embodiment 1.

FIG. 17 is a planar schematic view illustrating a configuration of a modification example of the liquid crystal display device according to Embodiment 1.

FIG. 18 is a planar schematic view illustrating a configuration of a modification example of the liquid crystal display device according to Embodiment 1.

FIG. 19 is a graph illustrating V-T characteristics of a liquid crystal display device that adopts an S-IPS mode.

FIG. 20 is a graph illustrating V-T characteristics of a liquid crystal display device that adopts the TBA mode.

FIG. 21 is a cross-sectional schematic diagram illustrating a configuration of a liquid crystal display device described in Patent Document 3.

FIG. 22 is a cross-sectional schematic diagram illustrating a configuration of a liquid crystal display device described in Patent Document 3.

FIG. 23 is a cross-sectional schematic diagram illustrating a configuration of the liquid crystal display device according to Embodiment 1.

FIG. 24 is a cross-sectional schematic diagram illustrating a configuration of the liquid crystal display device according to Embodiment 1.

### MODES FOR CARRYING OUT THE INVENTION

The present invention will be mentioned in more detail referring to the drawings in the following embodiments, but is not limited to these embodiments.

Note that in each of the following embodiments, it is assumed that a three o'clock direction, a twelve o'clock direction, a nine o'clock direction, and a six o'clock direction when the liquid crystal display device is viewed from the front, that is, when the active matrix substrate and opposed substrate surfaces are viewed in a planar manner, are a 0° direction (orientation), a 90° direction (orientation), a 180° direction (orientation), and a 270° direction (orientation), respectively, and also that a direction that passes through three o'clock and nine o'clock is the horizontal direction, and a direction that passes through twelve o'clock and six o'clock is the vertical direction.

Further, in the following drawings, although only several picture elements (subpixels) are shown, a plurality of picture elements are provided in a matrix shape in a display area (image display region) of the liquid crystal display device of each embodiment.

### EMBODIMENT 1

A liquid crystal display device according to the present embodiment adopts a system referred to as a “TBA system (TBA mode)” among transverse electric field systems that perform image display by causing an electric field (transverse electric field) in a substrate surface direction (direction parallel to a substrate surface) to act on a liquid crystal layer to thereby control the alignment of liquid crystal molecules.

The liquid crystal display device of the present embodiment includes a liquid crystal display panel. As shown in FIG. 2, the liquid crystal display panel has an active matrix substrate (TFT array substrate) 1 and an opposed substrate 2 that are a pair of substrates disposed facing each other, and a liquid crystal layer 3 that is sandwiched between the substrates 1 and 2.

A pair of linear polarizers are provided on an outer principal surface (opposite side to the liquid crystal layer 3) of the active matrix substrate 1 and the opposed substrate 2. The pair of linear polarizers are disposed in a cross-Nichol arrangement. An absorption axis of one of the pair of linear polarizers is arranged in the vertical direction, and an absorption axis of the other of the pair of linear polarizers is arranged in the horizontal direction. Thus, an excellent contrast ratio can be achieved with respect to the horizontal and vertical directions. This is particularly preferable when utilizing the present embodiment for large-size liquid crystal display devices (including, among other things, televisions).

The active matrix substrate 1 and the opposed substrate 2 are attached to each other by a sealing material provided so as to surround the display area. The active matrix substrate 1 and the opposed substrate 2 are disposed so as to face each other through spacers such as plastic beads. The liquid crystal layer 3 is formed by filling a liquid crystal material as a display medium constituting an optical modulation layer in the gap between the active matrix substrate 1 and the opposed substrate 2.

The liquid crystal layer 3 includes a nematic liquid crystal material (p-type nematic liquid crystal material) that has positive dielectric anisotropy. Liquid crystal molecules of the p-type nematic liquid crystal material exhibit a homeotropic alignment when no voltage is applied thereto (when no electric field is generated by a pixel electrode and a common electrode that are described later) under the effect of an alignment regulating force of vertical alignment layers provided on surfaces on the liquid crystal layer 3 side of the active matrix substrate 1 and the opposed substrate 2. More specifically, when no voltage is applied, the long axis of liquid crystal molecules of the p-type nematic liquid crystal material in the vicinity of the vertical alignment layers has an angle of 88° or more (preferably, 89° or more) with respect to the active matrix substrate 1 and the opposed substrate 2, respectively.

Thus, since the liquid crystal display panel of the present embodiment has a pair of polarizers that are disposed in a cross-Nichol arrangement and the vertical-alignment type liquid crystal layer 3, the liquid crystal display panel is of a normally black mode.

Panel retardation dΔn (the product of a cell gap d and a birefringence index Δn of the liquid crystal material) is preferably 275 to 460 nm, and more preferably 280 to 400 nm. Thus, the lower limit of dΔn is preferably not smaller than a half of the wavelength of green, 550 nm, in consideration of the mode, while the upper limit of dΔn is preferably within a range where dΔn can be compensated by the retardation Rth in a normal direction of a negative C-plate monolayer. The negative C-plate is provided so as to compensate for white floating and/or color-tone change occurring when the direction of observing a black image is shifted from the normal direction of the display screen to a direction tilted therefrom. Although it is also conceivable to stack multiple negative C-plates to increase Rth, such a method increases costs.

The dielectric constant Δ∈ of the liquid crystal material is preferably between 10 and 25, and more preferably is between 15 and 25. The lower limit of Δ∈ is preferably about 10 (more preferably 15) or more, since the white voltage (voltage when displaying white) is high. Further, Δ∈ is preferably as large as possible, since the driving voltage can be decreased more. However, if use of a material that is currently easily obtainable is assumed, as described above, it is preferable that the upper limit of Δ∈ is 25 or less.

The opposed substrate 2 includes, on one principal surface (on the liquid crystal layer 3 side) of a colorless, transparent insulating substrate, a black matrix (BM) layer that blocks light between each picture element, a plurality of color layers (color filters) provided in correspondence with the respective picture elements, and a vertical alignment layer provided on a surface on the liquid crystal layer 3 side so as to cover the aforementioned layers. The BM layer is formed from a non-transparent metal such as Cr or a non-transparent organic film such as an acrylic resin including carbon, and is formed in a region that corresponds to a boundary region of adjacent picture elements. The color layers are used to perform color display, and are formed from a transparent organic film such as an acrylic resin containing a pigment, and are mainly formed on picture element regions.

Thus, the liquid crystal display device of the present embodiment is a color liquid crystal display device (active matrix liquid crystal display device for color display) that includes color layers on the opposed substrate 2, in which one pixel is constituted by three picture elements that output colored light of R (red), G (green) and B (blue), respectively. Note that the types and number of colors of the picture elements constituting each pixel are not particularly limited, and can be appropriately set. Thus, in the liquid crystal display device of the present embodiment, each pixel may be constituted, for example, by picture elements of three colors, for example, cyan, magenta, and yellow, or may be constituted by picture elements of four or more colors.

Further, to make the surface on the liquid crystal layer 3 side of the opposed substrate 2 flatter, it is preferable to form a transparent organic film referred to as an “overcoat layer” at a position that is nearer to the liquid crystal layer 3 side than the color layers. Acrylic resin may be mentioned as an example of the organic film material, and the film thickness of the organic film is preferably between 1 and 5 μm. It is also preferable to provide the overcoat layer from the viewpoint of preventing impurities eluting to the liquid crystal layer 3 from the BM layer and the color layers.

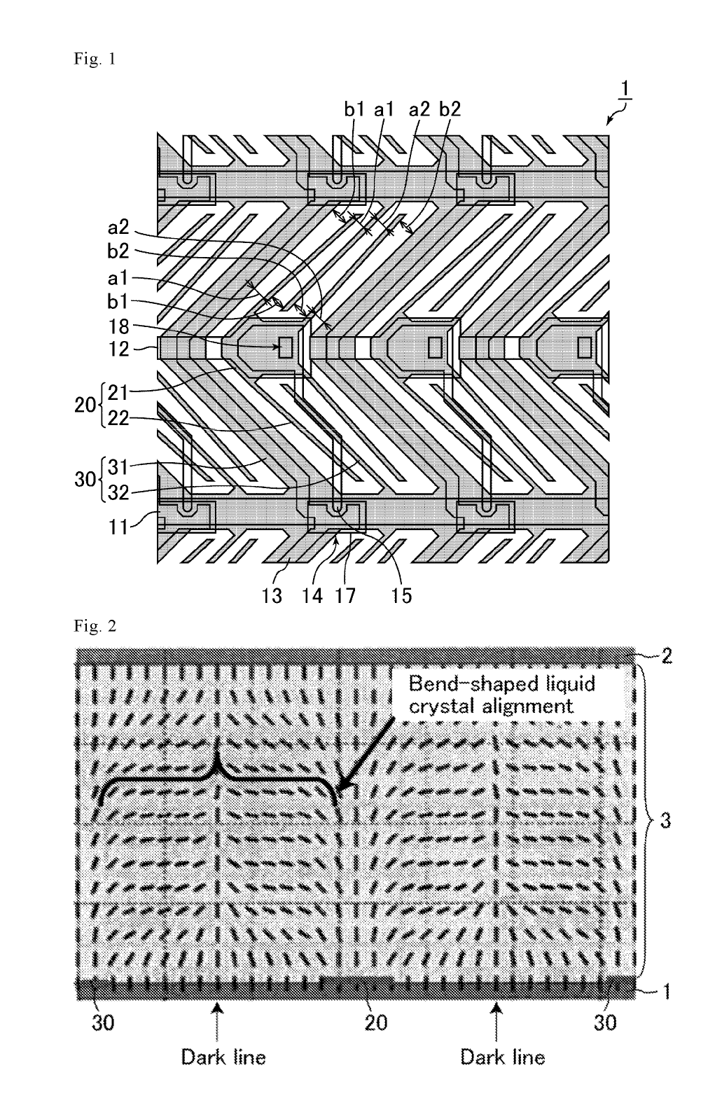

As shown in FIG. 1, the active matrix substrate 1 includes, on one principal surface (surface on the liquid crystal layer 3 side) of a colorless, transparent insulating substrate, gate bus lines 11, Cs bus lines 12, source bus lines 13, thin film transistors (TFT) 14 as switching elements (active elements) that are provided individually for each picture element, drain wiring (drain) 15 connected to each TFT 14, pixel electrodes (drain electrodes) 20 that are individually provided for each picture element, a common electrode 30 that is commonly provided for each picture element, and a vertical alignment layer that is provided on the surface on the liquid crystal layer 3 side to cover the above-described configuration. Each TFT 14 includes a semiconductor layer 17 that is formed in an island shape on the gate bus line 11.

With respect to the cross-sectional structure, the gate bus lines 11 and the Cs bus lines 12 are formed on the insulating substrate, a gate insulator is formed on the gate bus lines 11 and the Cs bus lines 12, the semiconductor layer 17 is formed on the gate insulator, the source bus lines 13 and the drain wiring 15 are formed on the gate insulator and the semiconductor layer 17, an insulation layer (interlayer insulation layer) is formed on the source bus lines 13 and the drain wiring 15, and a pixel branch portion 22 and a common branch portion 32 are formed on the insulation layer (interlayer insulation layer).

Thus, the TFT 14 is an inverted staggered structure TFT in which the gate is provided on a lower layer than the drain and source, and, for example, is manufactured by a process in which the semiconductor layer 17 also undergoes some degree of etching when separating the source bus lines 13 and the drain wiring 15. Further, the pixel branch portion 22 and the common branch portion 32 are disposed at positions that are further on the liquid crystal layer side than the gate bus lines 11 and the source bus lines 13.

The gate bus lines 11 and the Cs bus lines 12 may be formed on a higher layer than the source bus lines 13. For example, the semiconductor layer 17, the gate insulator, the gate bus lines 11 and Cs bus lines 12, a second insulation layer (interlayer insulation layer), the source bus lines 13 and drain wiring 15, the above described insulation layer (interlayer insulation layer), and a pixel electrode 40 and a common electrode 50 may be stacked in that order from the insulating substrate side. In this case, a staggered structure TFT or a planar-type TFT in which the gate is provided on a higher layer than the drain and source may be formed as the TFT 14.

Vertical alignment layers provided on the active matrix substrate 1 and the opposed substrate 2 are formed by coating a known alignment layer material such as polyimide. Although the vertical alignment layers are normally not subjected to a rubbing process, the vertical alignment layers can align liquid crystal molecules in a substantially vertical direction relative to the layer surface when no voltage is applied.

On the principal surface on the liquid crystal layer 3 side of the active matrix substrate 1, pixel electrodes 20 are provided in correspondence to each picture element, and a common electrode 30 is provided that is formed in a continuous (integral) manner for all adjacent picture elements. The pixel electrode 20 and common electrode 30 correspond to the above described pair of electrodes having a comb-tooth shape.

Image signals at a predetermined level are supplied to the pixel electrode 20 from the source bus line 13 (width of, for example, 2 to 10 μm) through the TFT 14. The source bus line 13 extends in the vertical direction between adjacent picture elements. Each pixel electrode 20 is electrically connected to the drain wiring 15 in the TFT 14 via a contact hole 18 provided in the interlayer insulation layer. On the other hand, a common signal that is common to each picture element is supplied to the common electrode 30. The common electrode 30 is connected to a circuit that generates a common signal (common voltage generation circuit), and is set to a predetermined potential (for example, 0 V).

Note that the source bus line 13 bends backward and forward in a zigzag manner in a V shape. More specifically, the source bus line 13 has a planar shape in which a portion that extends in a 225° direction and a portion that extends in a 315° direction are connected. The source bus line 13 is connected to a source driver (data line drive circuit) outside the display area. The gate bus line 11 (width of, for example, 5 to 15 μm) extends in the horizontal direction between adjacent picture elements. Thus, the source bus line 13 and the gate bus line 11 intersect with each other. A picture element is roughly defined as a region surrounded by the gate bus line 11 and the source bus line 13. The gate bus line 11 is connected to a gate driver (scanning line drive circuit) outside the display area, and functions as a gate of the TFT 14 inside the display area. Pulsed scanning signals are supplied at a predetermined timing from the gate driver to the gate bus line 11. The scanning signals are applied for each TFT 14 by a line sequential method. The TFT 14 enters an on state for only a fixed period upon input of a scanning signal, and while the TFT 14 is in an on state, the image signals are applied at a predetermined timing to the pixel electrode 20 connected to the TFT 14. Thus, the image signals are written in the liquid crystal layer 3.

After being written to the liquid crystal layer 3, the image signals are retained for a fixed period between the pixel electrode 20 to which the image signals are applied and the common electrode 30 that faces the pixel electrode 20. That is, a capacitance (liquid crystal capacitance) is formed for a fixed time period between the pixel electrode 20 and the common electrode 30. In order to prevent leakage of the image signals that are retained, a storage capacitance is formed in parallel with the liquid crystal capacitance. The storage capacitance is formed in each picture element between the drain wiring 15 of the TFT 14 and the Cs bus line 12 (storage capacitance wiring, with a width of, for example, 2 to 15 μm) that is provided in parallel with the gate bus line 11. The gate bus line 11 and the Cs bus line 12 are linearly formed in the horizontal direction.

The pixel electrode 20 is formed from a transparent conductive film such as an ITO film, or from a metal film such as an aluminum or chrome film. The pixel electrode 20 has a comb-tooth shape when viewing the liquid crystal display panel in a planar view. More specifically, the pixel electrode 20 has a pixel trunk portion 21 that is provided in an island shape in the center of the picture element, and pixel branch portions (comb teeth) 22 that are linear in a planar view. The pixel branch portions 22 are connected to the pixel trunk portion 21, and are provided towards the upper or lower part of the picture element from the center of the picture element, more specifically, in directions that are at angles of approximately 45° or 315° from the pixel trunk portion 21. The pixel trunk portion 21 and the pixel branch portions 22 are connected by being formed in a continuous (integral) manner.

When the two substrates are viewed in a planar view, that is, when viewed from a normal direction with respect to the substrate surfaces, the pixel branch portion 22 is a portion formed in a linear shape in an oblique direction inside a picture element opening portion. In contrast, the pixel trunk portion 21 is a portion (connecting part) for connecting a plurality of the pixel branch portions 22.

The common electrode 30 is also formed from a transparent conductive film such as an ITO film, or from a metal film such as an aluminum film, and has a comb-tooth shape in a planar view in each picture element. More specifically, the common electrode 30 has a lattice-shaped common trunk portion 31, and common branch portions (comb teeth) 32 that are linear in a planar view. The common trunk portion 31 is provided in the vertical and horizontal directions so as to be superimposed in a planar manner on the gate bus line 11 and the source bus line 13. The common branch portions 32 are connected to the common trunk portion 31, and are provided towards the center of the picture element from above and below the picture element, more specifically, in directions that are at angles of 135° or 225° from portions positioned above and below the picture element of the common trunk portion 31. The common trunk portion 31 and the common branch portions 32 are connected by being formed in a continuous (integral) manner. Further, the common branch portions 32 are connected to a portion of the common trunk portion 31 that is superimposed in a planar manner on the gate bus line 11.

The common trunk portion 31 is disposed over the gate bus line 11 and the source bus line 13 so as to cover the gate bus line 11 and the source bus line 13. In this manner, the common trunk portion 31 is disposed inside the display area so as to block an electric field that is produced by the gate bus line 11 and the source bus line 13.

Similarly to the source bus line 13, a portion over the source bus line 13 of the common trunk portion 31 bends backward and forward in a zigzag manner in a V shape. More specifically, portions of the common trunk portion 31 that are superimposed in a planar manner on the source bus line 13 bend backward and forward in a zigzag manner in a 225° direction and a 315° direction.

When the two substrates are viewed in a planar view, that is, when viewed from a normal direction with respect to the substrate surfaces, the common branch portion 32 is a portion that is formed in a linear shape in an oblique direction in the picture element opening portion. In contrast, the common trunk portion 31 is a portion (connecting part) for connecting a plurality of the common branch portions 32.

Thus, the pixel branch portions 22 and the common branch portions 32 have mutually complementary planar shapes, and are disposed alternately with a spacing therebetween. That is, the pixel branch portions 22 and the common branch portions 32 are disposed facing each other on the same plane. In other words, the comb-tooth shaped pixel electrode 20 and the comb-tooth shaped common electrode 30 are disposed facing each other so that the comb teeth (pixel branch portions 22 and common branch portions 32) engage with each other. Further, the pixel electrode 20 and the common electrode 30 are formed by photolithography by patterning the same conductive film in the same process, and are disposed on the same layer (same insulation layer). Consequently, a transverse electric field can be formed at high density between the pixel electrode 20 and the common electrode 30, and thus the liquid crystal layer 3 can be controlled with greater precision, and a high transmittance can be realized.

Note that it is also possible to form the pixel electrode 20 and the common electrode 30 with different layers, or to form the two electrodes 20 and 30 on different layers. However, if the pixel electrode 20 and the common electrode 30 are not disposed on approximately the same plane, the direction of an electric field generated by the two electrodes 20 and 30 will not be completely horizontal with respect to the substrates 1 and 2, and will have a slight gradient. Consequently, the electric field will not be applied effectively to the liquid crystal layer 3, and a high transmittance will not be obtained. Otherwise, it will be necessary to increase the applied voltage to the liquid crystal layer 3 to ensure the transmittance, and this will lead to adverse effects such as an increase in the current consumption.

Further, if a difference in level arises at the boundary surface between the substrates 1 and 2 and the liquid crystal layer 3, the electric field will fluctuate at the portion having the difference in level, and the alignment of liquid crystal molecules will be disturbed and an alignment defect portion will arise. A display device according to a transverse electric field system is particularly susceptible to the influence of such a difference in level. At an alignment defect portion, not only does white brightness decrease and lead to generation of an afterimage, but the contrast also declines because liquid crystal molecules do not become vertical at the portion with the difference in level when no voltage is applied (when displaying black). This is another reason why it is preferable to add an overcoat layer on the opposed substrate 2 that includes a color filter. By disposing the pixel electrode 20 and the common electrode 30 on the same plane or on substantially the same plane, a boundary surface with the liquid crystal layer 3 of the substrate 1 can be made approximately flat. Accordingly, a display having a high contrast characteristic and little image roughness can be obtained.

Further, when the pixel electrode 20 and the common electrode 30 are formed using a conductive film on a higher layer than the source bus line 13 in this manner, disposal of the common electrode 30 on the source bus line 13 and/or the gate bus line 11 is easily facilitated. More specifically, without adding to the layers or number of processes, the influence of the potential of the source bus line 13 and/or the gate bus line 11 can be effectively blocked by the common electrode 30. Thus, a liquid crystal display panel can be obtained in which the occurrence of a shadow and/or an alignment defect portion due to the influence of an image signal flowing through the source bus line 13 can be suppressed, and which also can suppress the occurrence of unevenness and/or blemishes caused by ionic substances and the like that accumulate in the vicinity of the gate bus line 11.

In the liquid crystal display device of the present embodiment, an electric field (transverse electric field) is generated between the pixel electrode 20 and the common electrode 30 in the surface direction (horizontal direction, direction parallel with the substrate surface) of the substrates (active matrix substrate 1 and opposed substrate 2) by applying image signals (voltages) to the pixel electrode 20 via the TFT 14. The liquid crystals are driven by this electric field to change the transmittance of each picture element, to thereby display an image.

Specifically, the liquid crystal display device of the present embodiment forms an electric-field strength distribution in the liquid crystal layer 3 by applying an electric field. Thereby, the alignment of the liquid crystal molecules is distorted. This distortion is utilized to change the retardation of the liquid crystal layer 3. More specifically, the initial alignment state of the liquid crystal layer 3 is a homeotropic alignment. When a voltage is applied to the comb-tooth shaped pixel electrode 20 and common electrode 30, a parabolic electric field is formed between the electrodes 20 and 30. Since this electric field is a substantially horizontal electric field (transverse electric field) with respect to the principal surfaces of the substrates 1 and 2 in an optical transmission region of the liquid crystal layer 3, it is generally referred to as a “transverse electric field”. As a result, liquid crystal molecules of the nematic liquid crystal material align in an arch shape (bend alignment), and as shown in FIG. 2, two domains in which director directions differ by 180° from each other are formed between the two electrodes 20 and 30.

Note that in a region in which two domains are adjacent to each other (normally on the center line of the gap between the pixel electrode 20 and the common electrode 30), the liquid crystal molecules always align vertically, regardless of the applied voltage value. Therefore, in this region (boundary) a dark line is always generated, regardless of the applied voltage value.

As shown in FIG. 1, the pixel electrode 20 and the common electrode 30 have two kinds of pixel branch portions 22 and two kinds of common branch portions 32, respectively, whose extending directions are substantially orthogonal to each other. Therefore, two kinds of transverse electric fields whose electric field directions are orthogonal to each other are generated in the liquid crystal layer 3. The two kinds of transverse electric fields are formed within a single picture element. More specifically, since two domains are formed by each of the respective kinds of the pixel branch portions 22 and the common branch portions 32, a total of four domains are formed within a single picture element. Further, the pixel electrode 20 and the common electrode 30 have a substantially symmetric planar shape with respect to a horizontal center line that passes through the center of the picture element. Therefore, since four domains are formed in an equal manner within a picture element, favorable viewing angle characteristics can be obtained.

From the viewpoint of increasing the transmittance, it is preferable that the widths (minimum width) of the pixel branch portion 22 and the common branch portion 32 are as narrow as possible, and according to the current process rule, it is preferable to set the widths to approximately 1 to 4 μm (more preferably 2.5 to 4.0 μm). Hereunder, the widths of the pixel branch portion 22 and the common branch portion 32 are also referred to simply as “line width L”.

According to the present embodiment, as shown in FIG. 1, two pixel branch portions 22 that are adjacent through the common branch portion 32 are disposed in a truncated chevron shape and incline at angles of approximately several degrees (for example, 0.7 to 10°, more preferably 1.5 to 5°) with respect to the extending direction of the common branch portion 32 and the source bus line 13. More specifically, a spacing between the aforementioned two pixel branch portions 22 narrows from the root towards the distal end.

Thus, the spacing between the pixel electrode 20 and the common electrode 30 (more specifically, the spacing between the pixel branch portion 22 and the common branch portion 32 or common trunk portion 31; hereunder, also referred to as “electrode spacing”) continuously changes in the longitudinal direction of the pixel branch portion 22 and the common branch portion 32. Further, narrow electrode spacings a1 and a2 and wide electrode spacings b1 and b2 are formed between the pixel electrode 20 and the common electrode 30. Differing pixel branch portions 22 are the objects of the spacings a1 and a2. Furthermore, differing pixel branch portions 22 are the objects of the spacings b1 and b2. Note that the spacings a1 and a2 may be the same size or different sizes. Likewise, the spacings b1 and b2 may be the same size or different sizes. Further, the spacings a1 and a2 in the vicinity of the distal end of the pixel branch portions 22 and the spacings a1 and a2 in the vicinity of the root of the pixel branch portions 22 may be the same size or different sizes. Likewise, the spacings b1 and b2 in the vicinity of the distal end of the pixel branch portions 22 and the spacings b1 and b2 in the vicinity of the root of the pixel branch portions 22 may be the same size or different sizes. Although the specific sizes of the spacings a1, a2, b1 and b2 are not particularly limited, for example, the spacings a1 and a2 may be set to approximately 3 to 8 μm, and the spacings b1 and b2 may be set to approximately 5 to 12 μm.

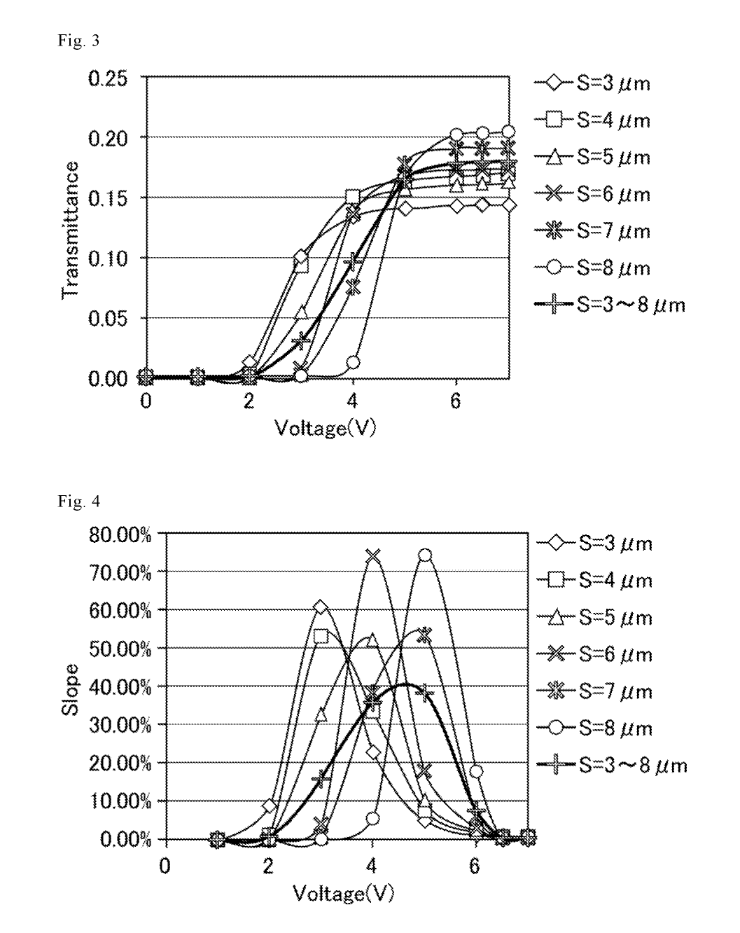

Simulated results with respect to the relation between electrode spacings and V-T characteristics in the TBA mode are described in the following. FIG. 3 shows a graph that illustrates V-T characteristics in a case where an electrode spacing S is set to 3 μm, 4 μm, 5 μm, 6 μm, 7 μm, or 8 μm, and in a case where the results when the electrode spacing S is set to 3 μm, 4 μm, 5 μm, 6 μm, 7 μm, or 8 μm are mixed (averaged). The line width L is fixed to 2.5 μm in each case. In the present embodiment, ExpertLCD manufactured by Jedat Inc. was used as a simulator.

The other simulation conditions are as follows:

Pixel electrode: AC (alternating current) voltage is applied (amplitude: 0 to 7 V, frequency: 30 Hz); provided that the Vc (potential at the amplitude center) is set to be the same potential as the potential of the common electrode

Common electrode: DC (direct current) voltage of 0 V is applied

dΔn: 400 nm

Δ∈: 22.6

The term “potential at the amplitude center” refers to the amplitude center potential.

As shown in FIG. 3, in the TBA mode, the V-T characteristics change significantly accompanying changes in the electrode spacing S. In this case, if the slope of the V-T curve can be made a gentle slope, only small changes will occur in the brightness when the electrode spacing S changes. As a result, unevenness of luminance such as localized variations in brightness or block separation that is caused by variations and/or changes in finish can be lessened. In FIG. 3, the V-T curve in a case where the electrode spacing S is mixed between 3 and 8 μm is gentle in comparison to the V-T curves for single spacings.

FIG. 4 shows the slopes of the V-T curves in FIG. 3. Based on FIG. 4, it is found that the slope of the V-T curve is made smaller by mixing a plurality of electrode spacings S.

As described above, as means for changing the electrode spacing S, it is effective to dispose the pixel branch portion 22 and the common branch portion 32 at an angle, and not parallel to each other. Note that, preferably an angle θ formed between the longitudinal direction of the pixel branch portion 22 and the longitudinal direction of the common branch portion 32 is set to an appropriate angle that takes the response time and transmittance into consideration and is also in accordance with the picture element size, and for example, the angle θ may be set to between approximately 0.7 to 10°, and more preferably 1.5 to 5°.

Next, simulated results of a simulation carried out with respect to brightness changes in a case where the electrode spacing S is changed and variations in finish have arisen are described. To simplify the description, a case is described in which two kinds of electrode spacings are mixed.

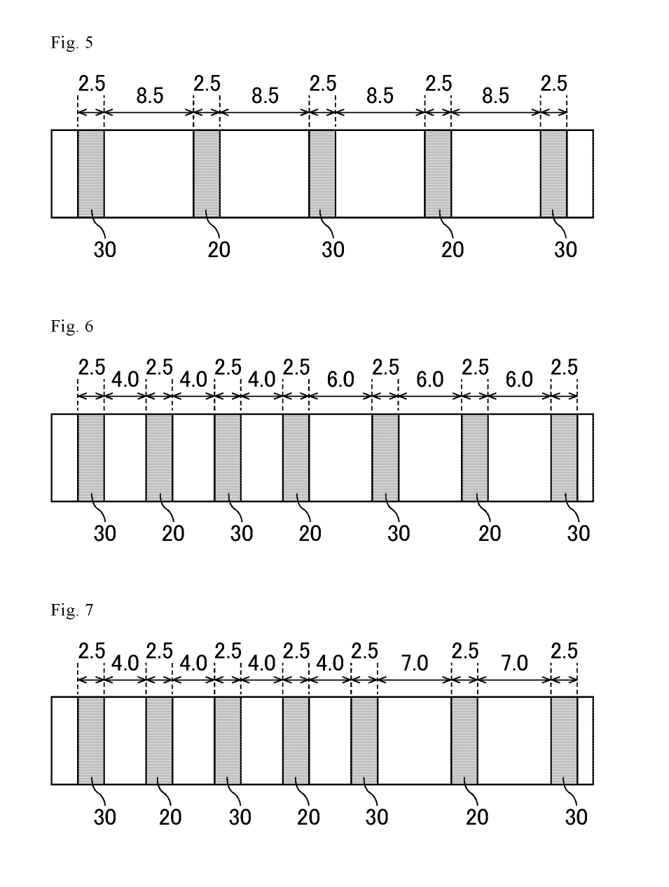

FIG. 5 is a planar schematic view illustrating an electrode pattern according to a comparative form, that illustrates a form in which the electrode spacing S is set to 8.5 μm and the line width L is set to 2.5 μm. FIG. 6 is a planar schematic view illustrating an electrode pattern according to the present embodiment, that illustrates a form in which the electrode spacing S is set to 4.0 μm or 6.0 μm and the line width L is set to 2.5 μm. FIG. 7 is a planar schematic view illustrating an electrode pattern according to the present embodiment, that illustrates a form in which the electrode spacing S is set to 4.0 μm or 7.0 μm and the line width L is set to 2.5 μm. Note that the sizes of picture element opening portions of the patterns shown in FIGS. 5 to 7 are set so as to be equal.

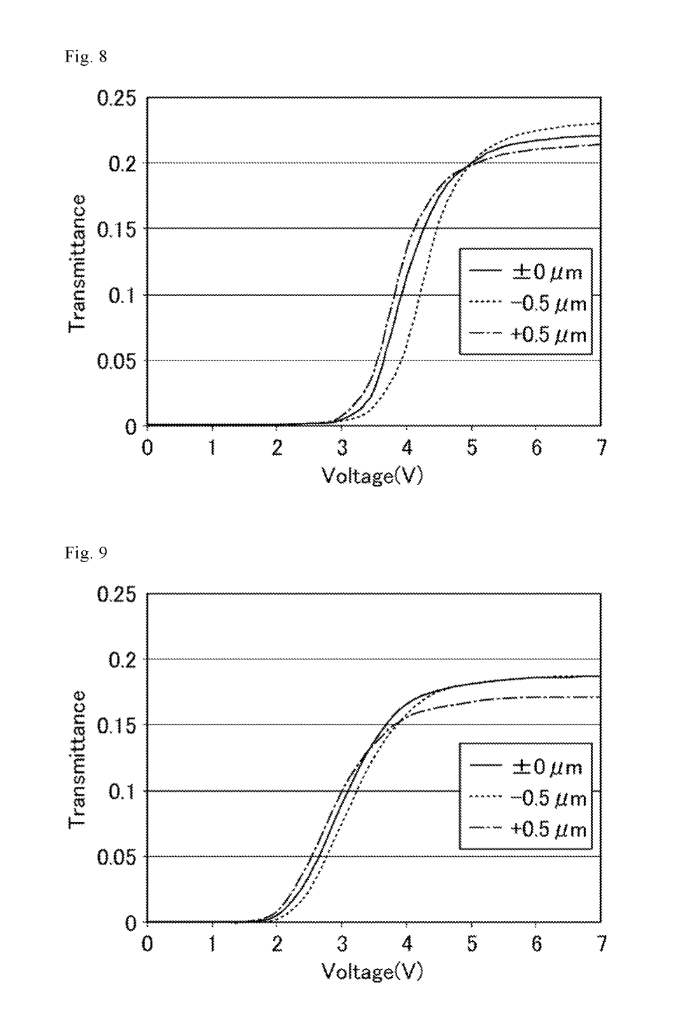

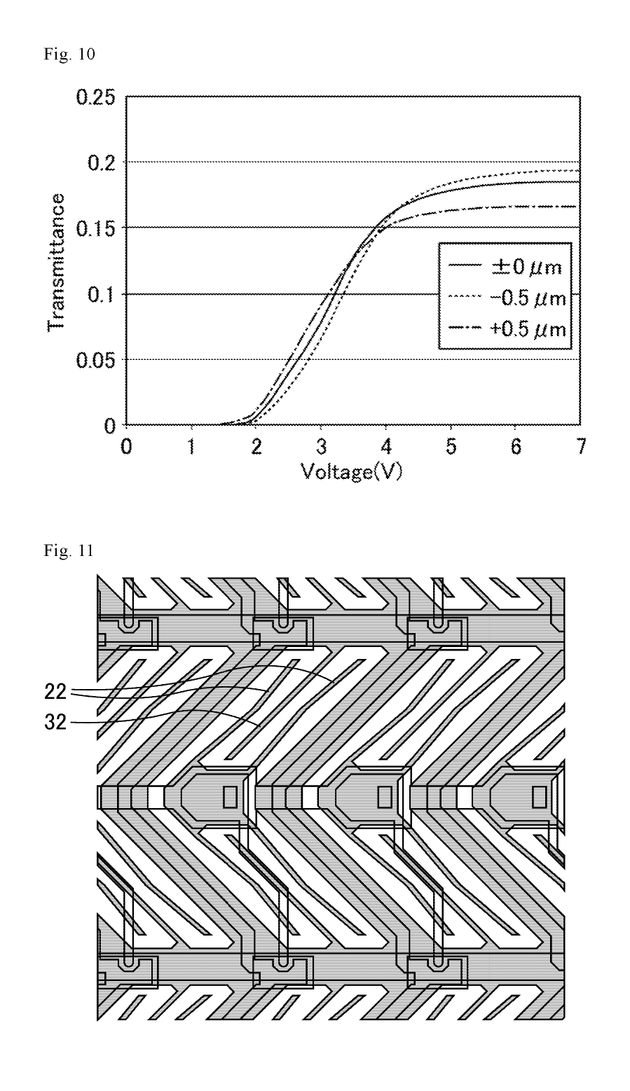

The simulated results for the V-T characteristics of each of the electrode patterns shown in FIGS. 5 to 7 are shown in FIGS. 8 to 10 and Tables 1 to 3. The simulation conditions are the same as the conditions described in FIG. 3. FIGS. 8 to 10 and Tables 1 to 3 respectively show the results for a case in which the electrode patterns are formed as shown in FIGS. 5 to 7 (standard pattern), a case in which the line width L is thickened by 0.5 μm from the state shown in FIGS. 5 to 7 (+0.5 μm pattern), and a case in which the line width L is made thinner by 0.5 μm from the state shown in FIGS. 5 to 7 (−0.5 μm pattern). Tables 1 to 3 also show the normalized transmittance and the brightness ratio with respect to the standard pattern. The normalized transmittance is a percentage for each of the brightnesses with respect to the brightness of the standard pattern when a voltage of 7 V is applied. The brightness ratio with respect to the standard pattern is a percentage of the normalized transmittance of the +0.5 μm or −0.5 μm pattern with respect to the normalized transmittance of the standard pattern at each voltage.

TABLE 1

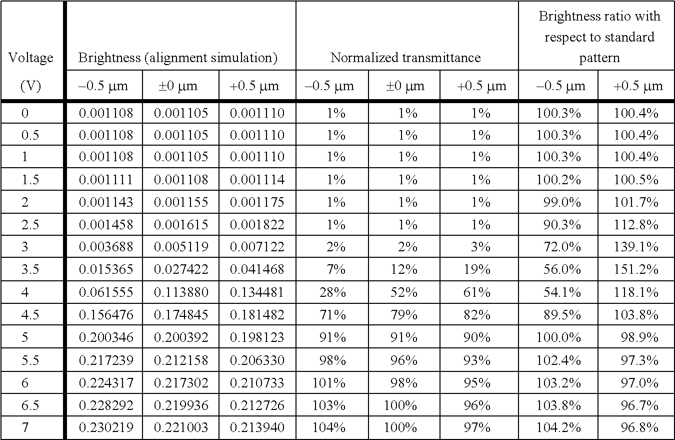

TABLE 2

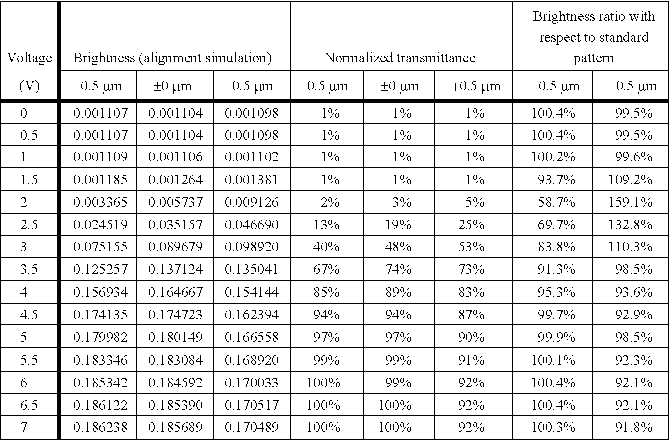

TABLE 3

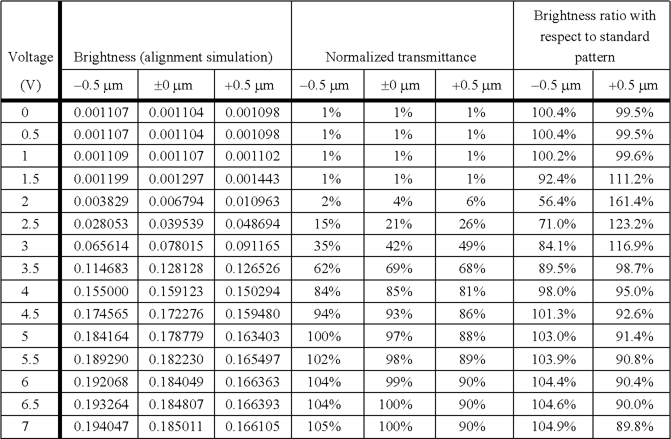

These results show that a change in the brightness ratio at a gradation that has a transmittance of approximately 10 to 20% (cells shaded gray in Tables 1 to 3) at which unevenness of luminance is most noticeably recognized visually is approximately 50% according to the comparative form, while in contrast, in the embodiment in which two kinds of electrode spacings S are provided, the aforementioned change in the brightness ratio is reduced by roughly half to approximately 20 to 30%. This is because the slope of the V-T curve is gentler.

Thus, by continuously changing the electrode spacing S along the longitudinal direction of the pixel branch portion 22 and the common branch portion 32, that is, by adopting a multi-space structure, the slope of the V-T curve can be made gentle, and it is difficult to visually recognize unevenness of luminance even if variations arise in the finish.

A modification example of the present embodiment is described hereunder.

As shown in FIG. 11, two pixel branch portions 22 that are adjacent through the common branch portion 32 may be disposed in an X shape. In this case, the two pixel branch portions 22 bend in the vicinity of the center thereof in the longitudinal direction.

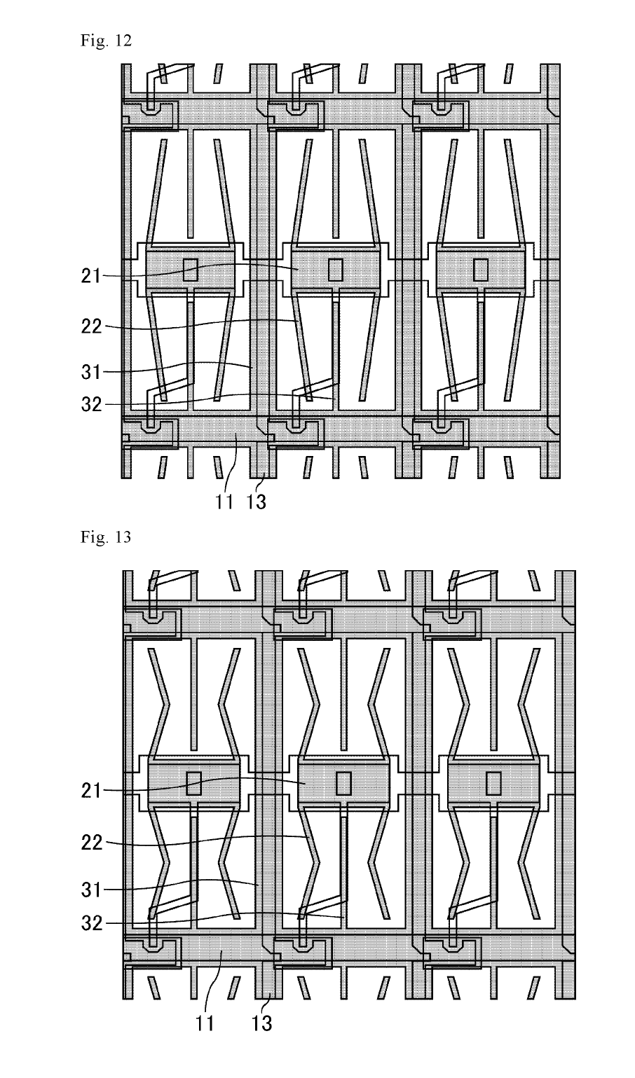

The number of domains formed inside a picture element is not particularly limited, and for example, may be two as shown in FIGS. 12 and 13. Even in this case, similarly to when there are four domains, an effect that suppresses unevenness of luminance is obtained.

FIG. 12 shows an example in which the form shown in FIG. 1 is modified to a form with two domains. FIG. 13 shows an example in which the form shown in FIG. 11 is modified to a form with two domains. In these examples, the source bus line 13 is linearly formed in the vertical direction. The common trunk portion 31 is provided in a lattice shape in the vertical and horizontal directions, and a portion of the common trunk portion 31 on the source bus line 13 is linearly formed in the vertical direction, similarly to the source bus line 13. The common branch portions 32 are provided in the 90° or 270° direction from portions disposed above and below the picture element of the common trunk portion 31. The pixel branch portions 22 are provided in approximately the 90° or 270° direction from the pixel trunk portion 21. In the example shown in FIG. 12, two pixel branch portions 22 that are adjacent through the common branch portion 32 are disposed in a truncated chevron shape. In the example shown in FIG. 13, two pixel branch portions 22 that are adjacent through the common branch portion 32 are disposed in an X shape.

In the modification example described below, to facilitate the description, a case is described in which there are two domains; however, a similar effect is also obtained when there are four domains.

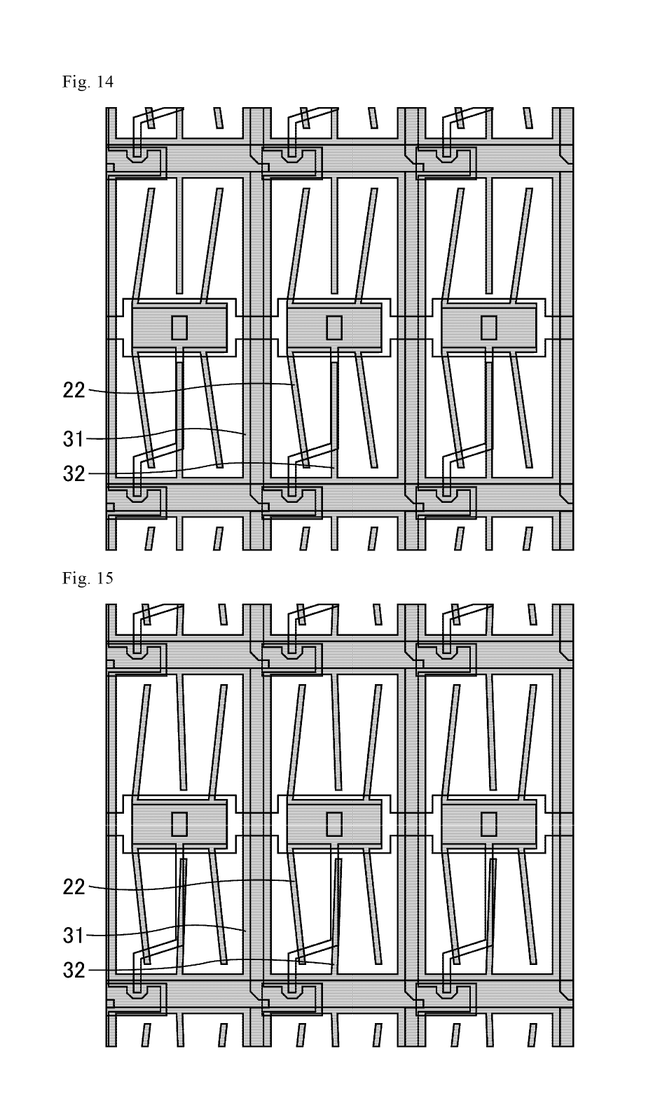

As shown in FIG. 14, two pixel branch portions 22 that are adjacent through the common branch portion 32 may be parallel to each other.

As shown in FIG. 15, the common branch portion 32 and a portion of the common trunk portion 31 on the source bus line 13 need not be parallel. In this example, the common branch portion 32 inclines at an angle of several degrees with respect to the extending direction of the source bus line 13. On the other hand, two pixel branch portions 22 that are adjacent through the common branch portion 32 are disposed in parallel with each other.

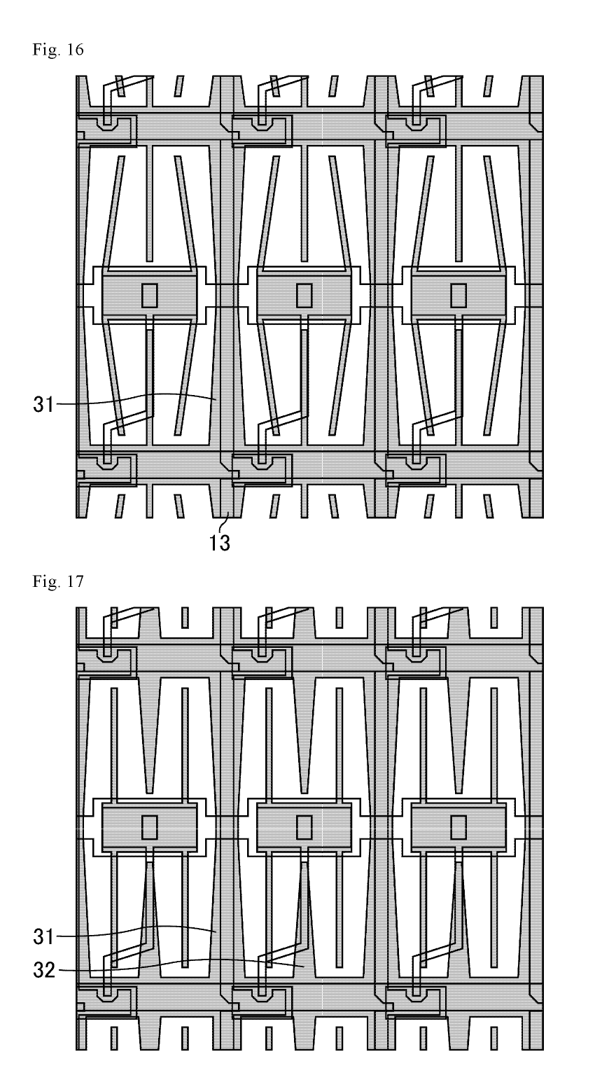

As shown in FIG. 16, facing edges (contour lines) of a portion of the common trunk portion 31 on the source bus line 13 need not be parallel. Similarly to the common trunk portion 31, as shown in FIG. 17, the common branch portion 32 may be trapezoid shaped. Note that although an example in which the common branch portion 32 is trapezoid shaped is shown in FIG. 17, the pixel branch portion 22 may be trapezoid shaped. Thus, at least one of the pixel branch portion 22 and the common branch portion 32 may be trapezoid shaped.

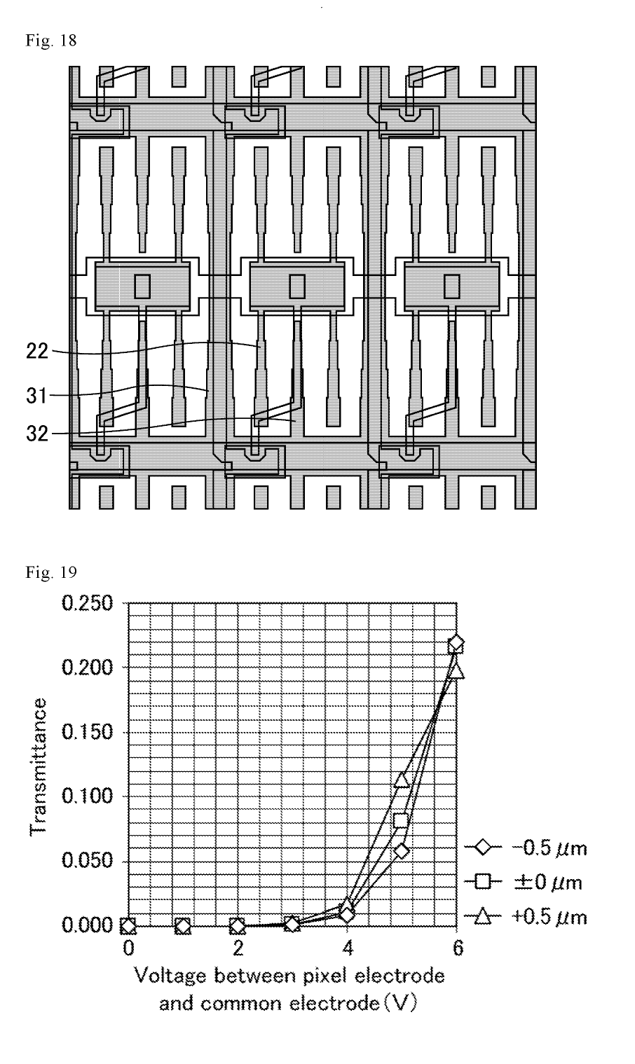

As shown in FIG. 18, the electrode spacing S may change in a stepwise manner in the longitudinal direction of the pixel branch portion 22 and the common branch portion 32. According to this example, the line width of the common trunk portion 31, the common branch portion 32 and the pixel branch portion 22 changes in a stepwise manner in the longitudinal direction, and the portions 31, 32, and 22 are each formed in a stepped shape.

The above described embodiment and modification examples may be appropriately combined.

Hereunder, the manner in which the above described effect of improving unevenness of luminance is exerted to a particularly noticeable degree in the TBA mode of the present embodiment compared to the IPS mode as well as the mode described in Patent Document 3 is described. First, the effects obtained in the IPS mode and in the TBA mode of the present embodiment are compared.

An S-IPS mode in which a pair of comb-tooth-shaped electrodes are disposed on the same layer may be mentioned as a mode having a structure that is influenced most by changes in the line width L with respect to the IPS mode. Note that in the case of the IPS mode in which a pair of electrodes are formed on different layers, the respective layers may independently become thick or thin, or alignment deviations may independently arise therein when patterning. Therefore, the respective changes are taken on an average basis to lessen the impact of such influences.

Thus, in order to compare and examine the degree to which unevenness of luminance is liable to occur when the line width L changes by the same amount in the S-IPS mode and the TBA mode of the present embodiment, the V-T characteristics when the line width L is changed were simulated. Note that dΔn for the S-IPS mode was taken as 350 nm, and dΔn for the TBA mode of the present embodiment was taken as 400 nm. The other simulation conditions are the same as the conditions described with respect to FIG. 3.

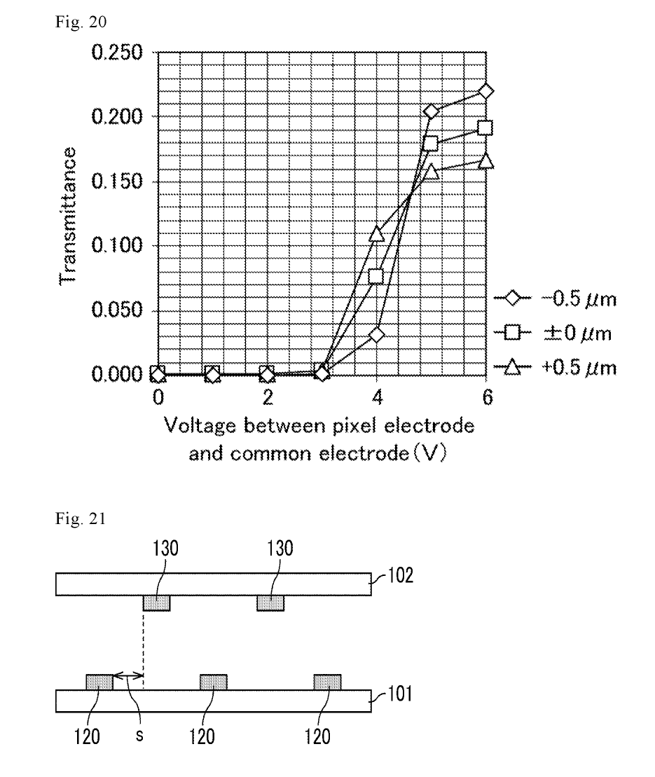

Results for a case where the electrode pattern is finished in accordance with the design value (standard pattern), a case where the line width L is 0.5 μm thicker than the design value (+0.5 μm pattern), and a case where the line width L is 0.5 μm narrower than the design value (−0.5 μm pattern) are shown in FIGS. 19 and 20 and Tables 4 and 5. Table 4 shows results for transmittance. The results shown in Table 5 are percentages for the transmittance of the +0.5 μm or −0.5 μm pattern with respect to the transmittance of the standard pattern for halftones (cells shaded gray in Table 4) at which unevenness of luminance is noticeably visible, and a white screen.

TABLE 4

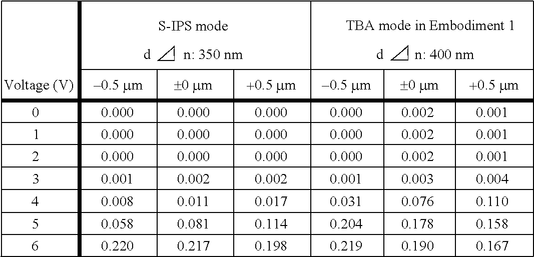

TABLE 5

| | S-IPS mode | | | TBA mode in Embodiment 1 | | |
|---|---|---|---|---|---|---|
| | −0.5 μm | ±0 μm | +0.5 μm | −0.5 μm | ±0 μm | +0.5 μm |
| Halftones | 70.9% | | 139% | 40.9% | | 144% |
| White | 101.5% | | 92% | 115.3% | | 88% |

The results show that changes in transmittance were greater in the TBA mode of the present embodiment with respect to both halftones and a white screen. That is, since the S-IPS mode does not respond with a high degree of sensitivity to changes in the widths of and spacing between a pair of comb-tooth-shaped electrodes, even if the S-IPS mode adopts a multi-space structure as in the present embodiment, the demonstrated effect of improving unevenness of luminance is less than the effect according to the present embodiment.

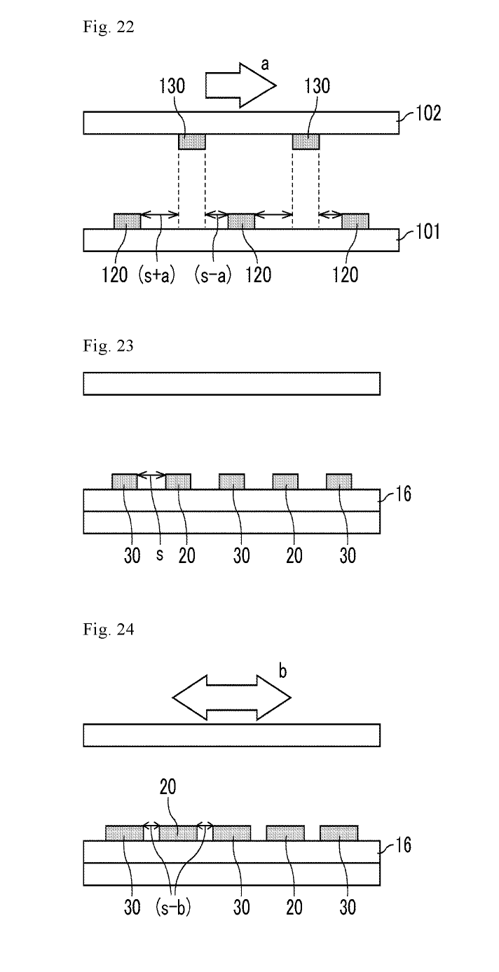

Next, results for the mode described in Patent Document 3 and the TBA mode of the present embodiment are compared. As shown in FIG. 21, according to Patent Document 3, a comb-tooth shaped pixel electrode 120 is formed on an active matrix substrate 101, a comb-tooth shaped common electrode 130 is formed on an opposed substrate 102, and liquid crystal is aligned using an oblique electric field that is formed between the electrodes 120 and 130. For example, when the design value of the spacing between the electrodes 120 and 130 is taken as “s”, if a position of bonding the active matrix substrate 101 and the opposed substrate 102 to each other deviates by a distance “a” as shown in FIG. 22, of the two electrode spacings adjacent to each electrode, although one electrode spacing widens to a width that is equal to (s+a), the other electrode spacing narrows to a width that is equal to (s−a). Consequently, a V-T curve for the wide electrode spacing shifts to the high voltage side, and a V-T curve for the narrow electrode spacing shifts to the low voltage side. Since the actual brightness is visually recognized as the average value of those two V-T characteristics, even without adopting a multi-space structure, the structure described in Patent Document 3 is in itself a structure that can lessen the influence of a bonding deviation between two substrates, within a picture element. Thus, according to Patent Document 3, the electrodes 120 and 130 are in a complementary relation with respect to a bonding deviation between two substrates, and the mode described in Patent Document 3 makes it even more difficult to receive the influence of a bonding deviation by adopting a multi-space structure.

In contrast, according to the TBA mode of the present embodiment, as shown in FIG. 23, the comb-tooth shaped pixel electrode 20 and common electrode 30 are disposed on the same plane (more specifically, on the interlayer insulation layer 16), and moreover, the two electrodes 20 and 30 are formed with the same layer. Consequently, if the line width of one of the electrodes narrows, the line width of the other electrode also narrows. Further, for example, when the design value of the electrode spacing is taken as “s”, if the line width of the pixel electrode 20 increases by a length b as shown in FIG. 24, the line width of the common electrode 30 also increases by the length b. As a result, all of the electrode spacings narrow to the amount (s−b). More specifically, according to the present embodiment, since the two electrodes can not have a complementary relation because of the structure thereof, it is easy for the electrode spacings to fluctuate significantly. As a result, in comparison to the mode described in Patent Document 3, the TBA mode of the present embodiment can obtain a more noticeable effect with respect to improving the unevenness of luminance.

The present application claims priority to Patent Application No. 2009-226117 filed in Japan on Sep. 30, 2009 under the Paris Convention and provisions of national law in a designated State, the entire contents of which are hereby incorporated by reference.

### REFERENCE SIGNS LIST

1, 101: Active matrix substrate (TFT array substrate)
2, 102: Opposed substrate
3: Liquid crystal layer
11: Gate bus line
12: Cs bus line
13: Source bus line
14: TFT
15: Drain wiring
16: Interlayer insulation layer
17: Semiconductor layer
18: Contact hole
20, 120: Pixel electrode
21: Pixel trunk portion
22: Pixel branch portion
30, 130: Common electrode
31: Common trunk portion
32: Common branch portion

1. A liquid crystal display device comprising a pair of substrates disposed facing each other, and a liquid crystal layer sandwiched between the pair of substrates, wherein:
one of the pair of substrates includes a pair of electrodes that include a comb-tooth shape;
the pair of electrodes are disposed to planarly face each other in a pixel, and are formed by patterning a same layer;
the liquid crystal layer includes p-type nematic liquid crystal, and is driven by an electric field generated between the pair of electrodes;
the p-type nematic liquid crystal is vertically aligned with respect to surfaces of the pair of substrates when no voltage is applied; and
a spacing between the pair of electrodes varies in a longitudinal direction of the pair of electrodes.

2. The liquid crystal display device according to claim 1, wherein the pair of electrodes are formed on a same layer.

3. The liquid crystal display device according to claim 1, wherein one of the pair of substrates comprises: a plurality of gate bus lines and a plurality of source bus lines that intersect; a plurality of pixels surrounded by the plurality of gate bus lines and the plurality of source bus lines; and a plurality of active elements provided in correspondence to each pixel.

4. The liquid crystal display device according to claim 3, wherein one of the pair of electrodes is disposed at a position that is further on the liquid crystal layer side than the plurality of gate bus lines and the plurality of source bus lines, and is disposed so as to be superimposed on at least one of the plurality of gate bus lines and the plurality of source bus lines.
